(19) United States
(12) Patent Application Publication
(10) Pub. No.: US 2024/0392819 A1
(43) Pub. Date: Nov. 28, 2024

(54) METHOD AND SYSTEM FOR CONNECTING MATERIALS WITH DIFFERENT COEFFICIENTS OF THERMAL EXPANSION

(71) Applicant: PLX, Inc., Deer Park, NY (US)

(72) Inventors: Itai Vishnia, Setauket, NY (US); Pu Fan, New York, NY (US)

(21) Appl. No.: 18/668,437

(22) Filed: May 20, 2024

Related U.S. Application Data
(60) Provisional application No. 63/503,885, filed on May 23, 2023.

(51) Int. Cl. F16B 5/06

(52) U.S. Cl. CPC F16B 5/0607

(57) ABSTRACT

An apparatus for connecting one or more parts having different coefficients of thermal expansion. The apparatus includes a clamp configured to attach to a support, wherein the clamp includes a first arm member having a first contact surface, a second arm member having a second contact surface, a recess formed by the first arm member and the second arm member, and a third arm member positioned perpendicular to at least one of the first arm member and the second arm member, the third arm member having a compransion zone. The apparatus also includes a base configured to hold a component, the base comprising a body that holds the component in a fixed position, and an interface configured to engage or attach to at least one of the first contact surface and the second contact surface. A width of the compransion zone is kept substantially equal to a width of the recess under varying temperature conditions to minimize or eliminate any stress to the support caused by thermal expansion or contraction of the clamp.

### CROSS REFERENCE TO RELATED APPLICATIONS

This application is entitled to and hereby claims priority under 35 U.S.C. § 119 (e) to provisional U.S. patent application Ser. No. 63/503,885, filed May 23, 2023, titled, “Method for Connecting Materials with Different CTEs and Avoiding Stress,” which is hereby incorporated herein in its entirety.

### TECHNICAL FIELD

The present disclosure relates generally to optics and laser technology, and more particularly to a method, apparatus, and system for accurately holding in position, securely fastening, and maintaining alignment of items with different coefficients of thermal expansion (CTEs) over changing temperatures.

### BACKGROUND

Lasers and, more generally, laser technologies have a wide range of applications, ranging from metrology to autonomous vehicles to medicine, among many others. Such uses require high-precision optical, mechanical, and electrical components, such as, for example, but not limited to, lenses, collimators, fiber optics, beam splitters, prisms, polarizers, filters, mirrors, laser diodes, photodiodes, wiring, galvo motors, and solid-state devices. When such components are assembled, it is important to maintain alignment, accuracy, and precision over time and under varying conditions, including external stresses. Examples of external stresses that can affect alignment, accuracy, or precision include thermal expansion or contraction of the materials that make up the components or the structures that hold the components used in shaping and directing beams of coherent light.

In various applications, it is important that there is invariable alignment and positioning between mechanical and optical components, mechanical and other mechanical components, optical and other optical components. The inventors have discovered that there exists an unfulfilled need for an apparatus, system and methodology for accurately holding in position, securely fastening, and maintaining alignment of optical and mechanical components with different coefficients of thermal expansion (CTEs) over time and under varying conditions, including changing temperatures.

### SUMMARY

The present disclosure provides an apparatus, system, and method for accurately holding in position, securely fastening, and maintaining alignment of optical and mechanical components with different coefficients of thermal expansion (CTEs) under varying conditions.

According to an aspect of the disclosure, an apparatus is provided for connecting one or more parts having different coefficients of thermal expansion. The apparatus has a clamp configured to attach to a support, a base configured to hold a component, and an interface configured to engage or attach to at least one of the first contact surface and the second contact surface. The clamp includes a first arm member having a first contact surface, a second arm member having a second contact surface, a recess formed by the first arm member and the second arm member, and a third arm member positioned perpendicular to at least one of the first arm member and the second arm member, the third arm member having a compransion zone. The base includes a body that holds the component in a fixed position. A width of the compransion zone is kept substantially equal to a width of the recess under varying temperature conditions to minimize or eliminate any stress to the support caused by thermal expansion or contraction of the clamp. The component can include a beam steering assembly. The compransion zone can include at least one of one or more channels and one or more counter-channels. The interface can include an elastomer. The elastomer can include a thin polymer.

In various embodiments, at least one of the one or more channels and the one or more counter-channels can have a length equal to a height of the third arm member; and/or at least one of the one or more channels and the one or more counter-channels can include a plurality of longitudinal cuts along a length of the third arm member. The plurality of longitudinal cuts can be parallel to each other. The one or more channels can each comprise a longitudinal cut along a first side of the third arm member, and wherein the one or more counter-channels can each comprise a longitudinal cut along a second side of the third arm member, the second side being opposite the first side. The second side can include a contact surface. The interface can include three interface sections, each interface section being configured to be positioned between a surface of the support and one of said contact surface, the first contact surface, and the second contact surface.

The clamp, including the compransion zone, can be made of metal having a coefficient of thermal expansion aₘ and the support is made of glass having a coefficient of thermal expansion a_{g}. The compransion zone can be configured to mimic the coefficient of thermal expansion a_{g}under varying temperatures. The compransion zone can be further to cooperate with one or more fasteners to mimic the coefficient of thermal expansion a_{g}.

The body can include: a receiver configured to seat and secure the component to the base; and/or a pair of legs, either or both legs being configured to adjust a diameter of the receiver; and/or a longitudinal aperture configured to adjust a diameter of the receiver; and/or a pair of normal apertures, each normal aperture being configured to facilitate movement of one of the pair of legs.

The clamp and the base can be formed as a single monolithic structure.

The one or more fasteners can be configured to affix either the first arm member to the second arm member or the pair of legs to each other.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a monolithic part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a nonlimiting embodiment of an optical system comprising a component mount.

FIG. 2 shows a view of a portion of the optical system of FIG. 1, including an enlarged view of the component mount.

FIG. 3 shows another view of the portion of the optical system of FIG. 1, including the component mount.

FIG. 4 shows yet another view of the portion of the optical system of FIG. 1, including the component mount.

FIG. 5 shows a perspective view of a non-limiting embodiment of the component mount.

FIG. 6 shows another view of the component mount of FIG. 5.

FIG. 7 shows a partial view of the component mount of FIG. 5.

The present disclosure is further described in the detailed description that follows.

### DETAILED DESCRIPTION

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar monolithic parts throughout the several views of the drawings.

Current state of the art opto-mechanical assemblies are significantly limited in terms of the materials that can be used to make the components of the assemblies. For instance, there are a limited number of materials having similar CTE values that can be used to make the optical components and the mechanical components, especially in regard to metal and glass combinations having similar CTE values. Often there are other properties of these materials that are undesirable or make them unsuitable for a particular application. The instant disclosure provides a solution that allows for use or inclusion of materials in optical components and/or mechanical components (“opto-mechanical components”) with significantly different CTE values, thereby not limiting optical systems or opto-mechanical components based on materials. The solution avoids or eliminates stress caused by thermal variations, which otherwise can damage mating components, make the components go out of alignment, or cause the components to become loose.

The disclosure provides a component mount system and methodology that alleviate or eliminate damaging effects of any mismatch in CTE values between the material of an optical component or a mechanical component, such as, for example, the mounting portion (for example, glass mounting portion discussed below) and the material of a mechanical component, such as, for example, a clamping mechanism (for example, metal clamp and/or metal base discussed below), or the material of the component(s) affixed to the clamping mechanism. In the current state of the art, there are a limited number of metal-glass combinations where there is a close CTE value match between the metal material and the glass material. Often times there will be other properties of these materials that are undesirable or make them unsuitable for a particular application. The design and construction of the novel component mount system, as well as methodology, provides for a greater variety of materials to be used in making or assembling optical systems, and avoiding stress that might otherwise arise due to variations in temperature. For instance, the component mount system minimizes or eliminates stress caused by thermal expansion or contraction that can damage mating components, cause components to go out of optical and/or mechanical alignment, or cause components to loosen.

State of the art thermal compensation schemes involve counteracting dimensional changes based on temperature. This involves introducing additional materials and precisely controlling the length of each component in a direction of interest. That is, it is necessary to design each assembly so that as the part/dimension of interest changes with increasing or decreasing temperature, another part changes in the opposite direction. One example of this is a pendulum assembly in a grandfather clock. The disclosure provides a solution that eliminates the need for such intricacies. The disclosure provides a component mount system and methodology that adjusts to changing temperatures, including, for example, as a function of temperature.

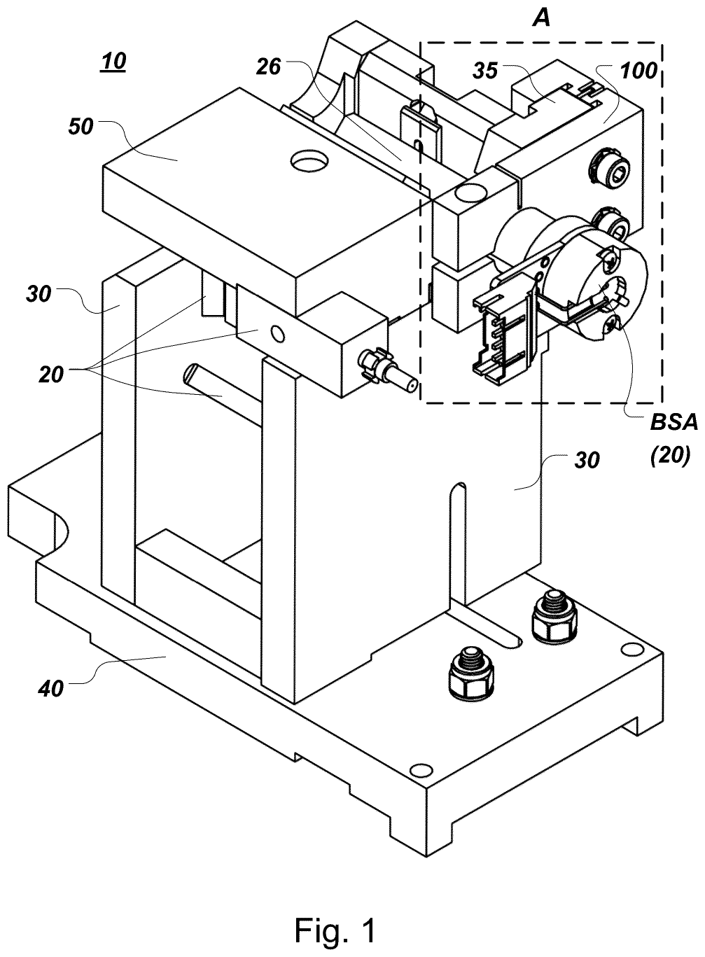

FIG. 1 shows a non-limiting embodiment of an optical system 10 that includes a plurality of components 20, a plurality of support members 30, a base 40, a cap 50, and a component mount system 100, constructed according to the principles of the disclosure. In various embodiments, the plurality of components 20 include one or more optical components, one or more mechanical components, and one or more electronic components. For example, the components 20 can include one or more of a lens, collimator, fiber optic, beam splitter, prism, polarizer, filter, mirror, laser diode, photodiode, line sensor, solid-state device, and a beam steering assembly BSA. One or more of the support members 30, base 40, and cap 50 can comprise a monolithic structure made of a material such as, for example, glass, metal, plastic, carbon fiber, or other rigid material, or a structure comprising a combination of the foregoing. In an embodiment of the optical system 10, the support members 30, base 40 and cap 50 are all made of glass.

In at least one embodiment, the optical system 10 includes a pair of monolithic parts made of a material (such as, for example, glass) that can be optically and mechanically aligned and connected to each other to form the optical system 10. One of the monolithic parts includes the support members 30 connected to and holding a plurality of components 20, including optical components and mechanical components, such that each optical component is optically aligned and positioned, each mechanical component is mechanically aligned and positioned, to shape and direct one or more light beams according to one or more predetermined paths. In the first monolithic part, the base 40 can be connected to the support members 30 (for example, as seen in FIG. 1) and formed as an integral part of the monolithic structure. As seen, one of the support members can include a mounting portion 35 to which a component 20 can be attached. In various embodiments, the component 20 can be affixed to the component mount system 100, which in turn can be fastened to the mounting portion 35 and configured to hold the component 20 in position, including in optical and mechanical alignment, as the optical system 10, including the mounting portion 35, the component 20, and the component mount system 100 undergo cooling, for example, to a temperature of −100° C., or heating, for example, to a temperature of +100° C.

The second monolithic part includes the cap 50, which can be connected to and hold one or more components 20, such that each optical component is optically aligned and positioned, and each mechanical component is mechanically aligned and positioned, to shape and direct one or more light beams according to one or more predetermined light beam patterns. The optical system 10 is configured such that when the first and second monolithic parts are connected, all of the components 20 are optically and mechanically positioned and aligned to shape and direct the one or more beams according to the one or more predetermined patterns.

Thermal deformation of parts of the optical system 10, including the components 20, the mounting portion 35, and the component mounting system 100, can occur when the material that makes up the part expands with heat or contracts with cold, depending on the temperature change ΔT, where ΔT=T₁−T₀, and T₀ is the initial temperature of the particular part, and T₁ is the temperature of that part at a later time, after experiencing a temperature change resulting from absorbing or releasing energy, including thermal energy. Various parts of the optical system 10 can absorb (or release) enough energy to undergo thermal change, including, for example, change in shape, size, position, reflectivity, refractive index, or performance, depending on the particular part. The change in performance can include changes in, for example, effective focal length, light beam shaping, light beam guiding, light beam travel, light beam positioning, light beam coherency, or light beam interference, among other changes. Such changes, in turn, can cause drift, scatter, and other negative effects on the light beam that the parts (for example, components 20) shape or direct.

When the components 20 are installed in the optical system 10, such as, for example, in the first or second monolithic parts discussed above, it is important that each component 20 be positioned and aligned to accurately and precisely shape (including, for example, focus, refract, polarize, filter, collimate) and direct (including, for example, refract, split, redirect, reflect, guide, steer, scan) one or more light beams, and to maintain alignment, accuracy, and precision of the components 20 and the light beam shaped or directed by such components over time and under varying conditions, including variable temperature conditions. The instant disclosure provides a system and methodology for maintaining constant and consistent positioning between components 20, including, for example, between mechanical components and optical components, between mechanical components and other mechanical components, and between optical components and other optical components, under varying stress conditions caused by changes in temperature.

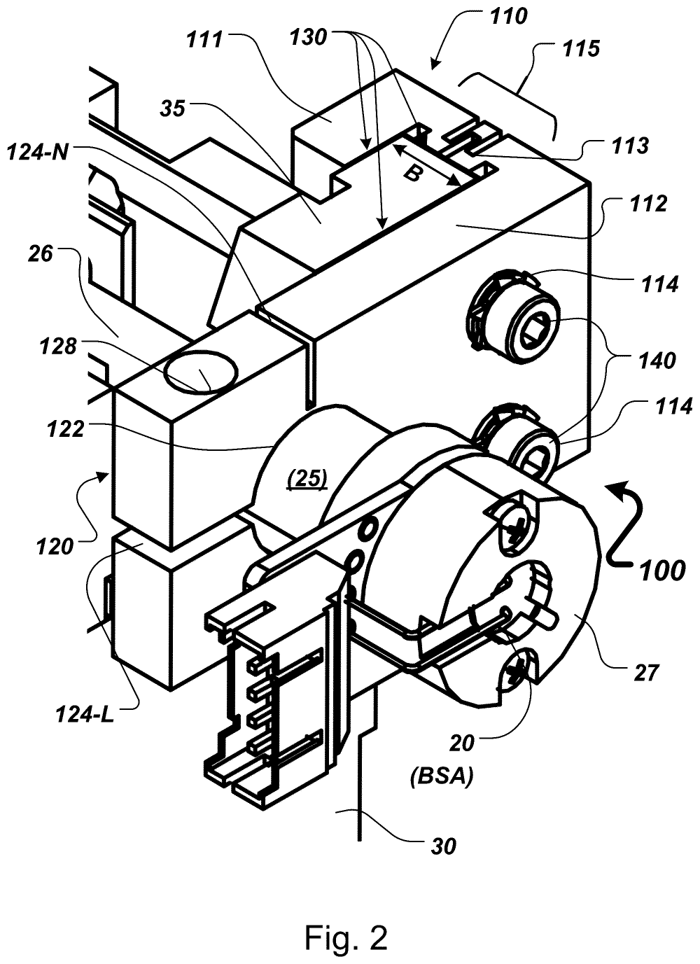

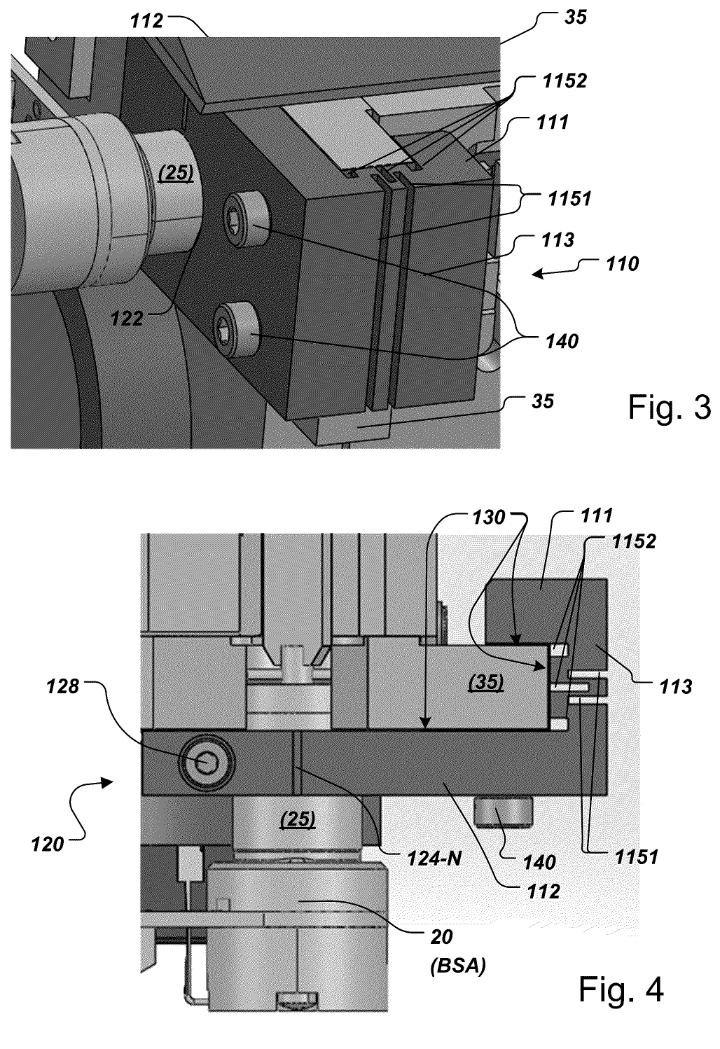

FIGS. 2-4 show enlarged views of a portion A of the optical system 10, including a perspective base-side view (FIG. 2), a perspective clamp-side view (FIG. 3), and a clamp-base side view (FIG. 4) of a limiting embodiment of the component mount system 100.

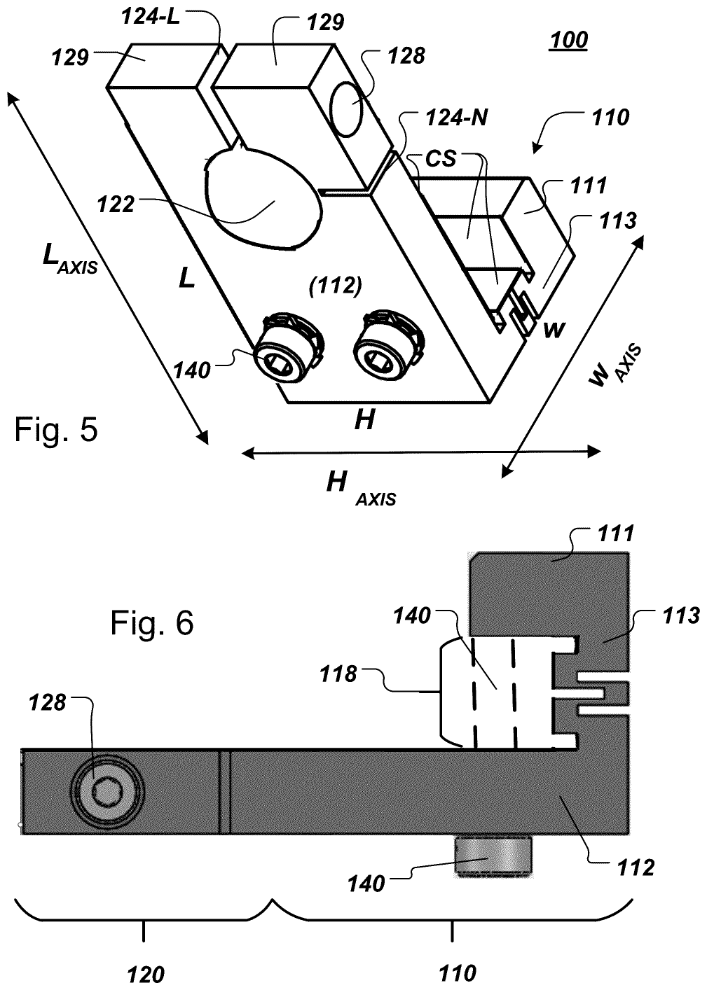

FIGS. 5 and 6 show perspective and side views, respectively, of the component mount system 100.

In various embodiments, the component mount system 100 includes a clamp 110, a base 120, and an interface 130. In certain embodiments, the component mount system 100 can include various combinations of the clamp 110, the base 120, or the interfaces 130.

Referring to FIGS. 1-6 concurrently, the clamp 110 has an arm comprising a plurality of arm members 111, 112, 113. Each of the arm members 111, 112, and 113 can be constructed to include a contact surface CS that is planar and configured to uniformly, and across its surface area, engage a structure such as, for example, the mounting portion 35, either directly or via the interface 130 as an intermediary. Each contact surface CS can be formed as, or machined to, a smooth, flat, protrusion-free, planar surface that can evenly distribute and apply a force across the area of the contact surface CS, without any protrusions or contact points. The contact surfaces CS on the arm members 111, 112 can be parallel to each other and perpendicular to the contact surface CS of the arm member 113. Either or both of the arm members 111, 112 can include one or more openings 114, each of which can be configured to receive a fastener 140. One or more of the openings 114 can include a threading that can engage a corresponding thread on the fastener 140. In at least one embodiment, the arm members 111, 112 each include a pair of openings 114, with each opening 114 in the arm member 111 being aligned with the corresponding opening 114 in the arm member 112 such that a fastener 140 can be inserted in and through the opening 114 on the arm member 111 (or 112) and extend into the corresponding opening 114 on the other arm member 112 (or 111), as depicted by the broken lines in FIG. 6. The fastener 140 can include, for example, a bolt, a nut, a screw, a pin, a rivet, or a weld.

The clamp 110 can be attached to the mounting portion 35 by aligning an edge of the mounting portion 35 with a recess 118 in the arm formed by the arm members 111, 112, 113 (shown in FIG. 6) such that the cross-section B of mounting portion 35 can slide into the clamp 110. The clamp 110 can be slid onto and along a portion of the mounting portion 35 until the contact surface CS of the arm member 113 (or, where provided, the interface 130) comes into contact with the edge surface of the mounting portion 35. After all three contact surfaces CS of the arm members 111, 112, 113 are in contact, either directly or through one or more respective interfaces 130, with the three corresponding planar surfaces of the mounting portion 35, the fasteners 140 can be installed.

In various embodiments, the mounting portion 35 includes openings (not shown) corresponding to the openings 114 on the arm members 111 and/or 112. In each of the embodiments in which the mounting portion 35 is made of glass, an elastomeric sleeve (not shown) can be provided in the opening in the mounting portion 35 to prevent direct contact between the fastener 140 and the inner walls of the opening to prevent fracture from any point contact between glass and fastener 140. In at least one embodiment, the mounting portion 35 includes a pair of openings that can be aligned with the corresponding openings 114 in the arm members 111 and/or 112. The openings in the mounting portion 35 can be configured such that, when the mounting portion 35 is sandwiched between the arm members 111, 112 (either directly or via the interfaces 13), the pair of fasteners 140 can be received and passed through, extending between the arm members 111 and 112, such that the arm members 111, 112, and, thereby the clamp 110, can be securely and immovably fastened to the mounting portion 35 by means of both the contact surfaces and the fasteners 140.

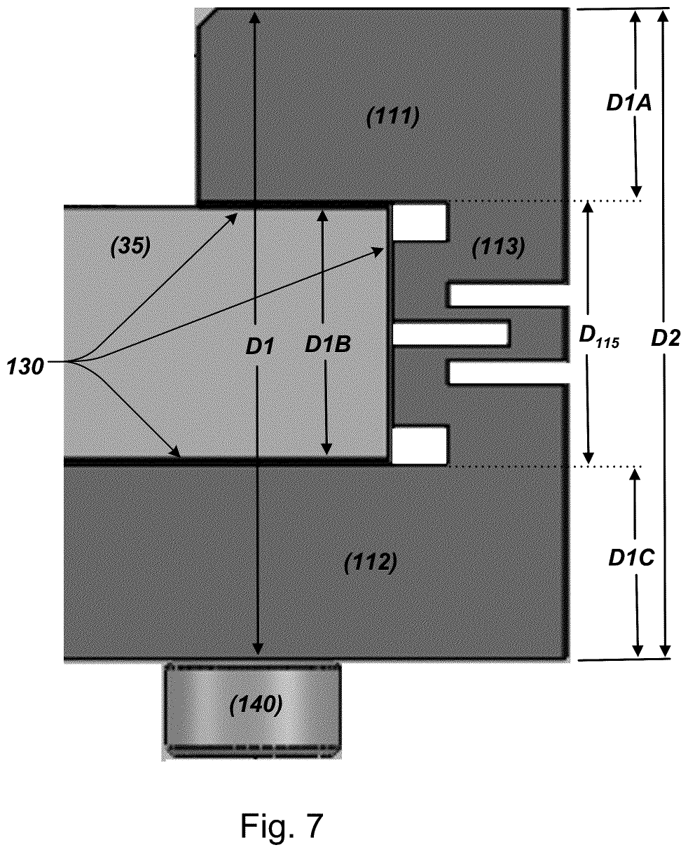

FIG. 7 shows a partial view of an embodiment of the clamp 110 fastened to the mounting portion 35. Referring to the FIGS. 1 and 7, the arm member 113 includes a compransion zone 115 having a width D₁₁₅ that is initially equal to a width D1B of the mounting portion 35. In an embodiment, the widths D₁₁₅ and D1B are equal to the width of the recess 118 (shown in FIG. 6) at a temperature of about 25° C.

The compransion zone 115 includes one or more longitudinal channels 1151 and one or more longitudinal counter-channels 1152. Each channel 1151 can be formed (or cut) along the entire height H of one side of the arm member 113 (e.g., along the longitudinal axis H_{AXIS}, shown in FIG. 5). Similarly, each counter-channel 1152 can be formed (or cut) along the entire height H on the opposite side of the arm member 113, including the formation (or cut) in the contact surface CS of the arm member 113 (e.g., along the longitudinal axis H_{AXIS}). The channel(s) 1151 and counter-channel(s) 1152 can be formed such that the height H of the arm member 113 compared to the width and depth of each channel is such that the strength of the clamp 110 is maintained, while allowing for a different rate of expansion or contraction of the compransion zone 115 than the rest of the arm member 113.

The channel(s) 1151 and counter-channel(s) 1152 are configured such that the compransion zone 115, and thereby the arm member 113, stretch or compress along a width W (e.g., along a width axis W_{AXIS}, shown in FIG. 5) of the clamp 110 (and the arm member 113) as a function of temperature change to limit stress on the clamped mounting portion 35, which can be made of glass in various embodiments. The width W (and W_{AXIS}) and height H (and H_{AXIS}) and length L (and longitudinal axis L_{AXIS}) of the clamp 110 are perpendicular to each other.

The channel(s) 1151 and counter-channel(s) 1152 can be formed (or cut) to provide counter-balanced expansion (stretching) and compression (contraction) of the compransion zone 115, such that width Dis of the compransion zone 115 increases or decreases solely along the width axis W_{AXIS} of the arm member 113, and perpendicular to both the height axis H_{AXIS} and length axis L_{AXIS}, thereby minimizing any change in force applied by the contact surface CS of the arm member 113 to the edge of the mounting portion 35 under varying temperature conditions. In certain embodiments, the channels 1151 and counter-channels 1152 can be configured to provide a spring effect such that the compransion zone 115 stretches and contracts along the width axis W_{AXIS} similar to a spring.

The base 120 includes a body and a receiver 122 configured to position and hold securely a component 20 such as, for example, a beam steering assembly BSA. The body of the base 120 can include one or more apertures 124 (for example, a longitudinal aperture 124-L and/or a normal aperture 124-N) and a fastener 128. In various embodiments, the aperture(s) 124 can be formed on one, two, or three sides of the base 120.

In certain embodiments, the base 120 includes a longitudinal aperture 124-L formed on one side of the body (parallel to the longitudinal axis L_{AXIS}) and either one or a pair of normal apertures 124-N formed on each of the two other sides of the body (along the height axis H_{AXIS}). In the embodiment comprising opposing apertures 124-N, each aperture 124-N can be aligned with the other aperture 124-N and formed across a portion of the height of the base 120, along the H_{AXIS}. The base 120 can be integrally formed as one piece with the clamp 110. In at least one embodiment, the arm member 112 comprises the body of the base 120, including the receiver 122 and the one or more apertures 124. In the embodiment, the arm member 112 has a length L (shown in FIG. 5).

In at least one embodiment, the beam steering assembly BSA includes a galvo mirror system having a mirror 26 mounted on a galvo motor 27, as seen in FIG. 1. In the embodiment, the BSA has a housing with a portion 25 that can be installed in the receiver 122. For example, the BSA can be installed by holding the housing and aligning the mirror 26 with the center of the receiver 122. Once aligned, the BSA can be installed by inserting the mirror 26 through the receiver 122 and continuing insertion with a part of the housing portion 25 traveling into the receiver 122 until the inner surface area of the receiver 122 is in contact with an outer surface area of the housing portion 25.

The housing portion 25 can have a cylindrical shape with a circular perimeter that matches or is substantially equal to an inner diameter of the receiver 122, such that the receiver 122 provides a snug fit with the housing portion 25 during installation.

Once the housing portion 25 is seated in the receiver 122, the fastener 128 can be installed and/or tightened, causing the diameter of the receiver 122 to be reduced until the housing portion 25 is fixedly and immovably secured to the body of the base 120.

In the embodiment having the longitudinal aperture 124-L and the pair of opposing normal apertures 124-N on each side of the body of the base 120, the longitudinal aperture 124-L can be perpendicular to each of the normal apertures 124-N. The longitudinal aperture 124-L can be configured to form a pair of legs 129 (shown in FIG. 5). The legs 129 can be configured to move toward each other (such as, for example, along the height axis H_{AXIS}), thereby reducing the diameter of the receiver 122, and move away from each other to increase the diameter of the receiver 122. Similarly, the normal apertures 124-N can be configured such that a width of the aperture increases (expands) to facilitate the legs 129 moving toward each other, and further configured such that the width of the aperture reduces (contracts) to facilitate the legs 129 moving away from each other. The longitudinal aperture 124-L and normal apertures 124-N can be configured to widen or narrow depending on the temperature such that the position and alignment of the component 20 (e.g., BSA) is maintained invariably under varying temperature conditions, including, for example, but not limited to, temperatures changes ranging from below −100° C. to above +100° C., or any temperature therebetween.

In various embodiments, one or both of the legs 129 can include an opening that is configured to receive the fastener 128. The fastener 128 can include, for example, a bolt, a nut, a screw, a pin, a rivet, or a weld. The opening can include a threading that is configured to engage a threaded portion of the fastener 128. In an embodiment comprising an opening in each of the legs 129, either or both openings can include a threading.

The interface 130 includes an elastomeric interface. In various embodiments, the elastomeric interface includes a coating (or thin layer) of an elastomer. An interface 130 can be provided between each contact surface CS of the arm 110 and a corresponding surface on the mounting portion 35 to prevent, for example, fracture from any point contact between the glass mounting portion 35 and the metal clamp 110. The interface 130, which can include a polymer, is configured to provide frictional force between the clamped parts—namely, the mounting portion 35 and the clamp 110. The interface 130 can be configured to be thin enough to be considered fully compressed in the assembly, as those skilled in the art will understand.

The component mount system 100, which includes a combination of at least one of the clamp 110, base 120, and interfaces 130, is configured to attach and secure to a glass structure, such as, for example, the mounting portion 35, and hold in position a component 20, such as, for example, the BSA, in position and in opto-mechanical alignment under varying temperature conditions. The component mount system 100 is configured to hold the component 20 invariably, maintaining the position and optical and/or mechanical alignment of the component 20 as temperature conditions change, such as, for example, from below −100° C. to above +100° C., or any temperature therebetween.

FIG. 7 shows a partial cross-section view of the clamp 110 affixed to the mounting portion 35. As seen, an interface 130 is provided between each of the contact surfaces CS of the arm members 111, 112, 113 and a surface of the mounting portion 35. In the Figure, DI is the overall width of the clamp 110, including the mounting portion 35 sandwiched in the arm of the clamp 110. The overall width D1 of the clamp 110 includes a width D1A of the arm member 111, the width D1B of the mounting portion 35, and a width D1C of the arm member 112. Initially, the overall width of the clamp 110 (including mounting portion 35) can be measured at a baseline temperature T_{BaseLine}, such as, for example, at 25° C., which is represented as a baseline width D2.

Referring to FIGS. 5 and 7 concurrently, the height H of the arm runs perpendicular to both the width W and the length L of the arm, with the width W being perpendicular to both the height H and the length L of the component mount system 100 (including the clamp 110 and base 120). The compransion zone 115 is configured to expand (stretch) or compress (contract) along the width axis W_{AXIS} and perpendicular to both the height axis H_{AXIS} and length axis L_{AXIS} of the clamp 110.

The compransion zone 115, including the channels 1151 and counter channels 1152, can be formed when the clamp 110 is manufactured, or can be formed after the clamp 110 is manufactured, such as, for example, by cutting each channel 1151 and/or counter channel 1152 into the sides of the arm member 113, along the entire height of the clamp 110. Each channel 1151 and counter channel 1152 can be formed to facilitate movement such as stretching or contracting and, thereby, limit stress on the mounting portion 35.

Referring to FIG. 7, initially the overall width D1 of the clamp 110 (including the width of the mounting portion 35) can be equal to the baseline width D2 (D1=D2) at the baseline temperature T_{BaseLine}, where D2 is a reference value that does not change. However, as temperature changes from, for example, the baseline temperature T_{BaseLine} to a current temperature T_{C}, the arm members 111 (width D1A), 112 (width D1C), 113 (width D1B), and mounting portion 35 (width D₁₁₅) can change as a function of the temperature T at different rates due to their materials having different respective CTE values, such that a limited width D1 (ΔT) will become smaller than the baseline width D2 (D2>D1) when temperature decreases, and larger than the baseline width D2(D2<D1) when temperature increases, but in both instances D1≠D3, where D3 is the overall unrestricted width of the arm members 111, 112, and 113, without the compransion zone 115 being included in the clamp 110. For example, because metal has a different CTE value than glass, the limited width D1 (ΔT) will be greater than the unrestricted width D3 at low temperatures (for example, between −100° C. and 0° C.), and smaller at high temperatures (for example, between 0° C. and 100° C.), since metal typically contracts more than glass at low temperatures, and expands more than glass at high temperatures.

In the various embodiments, the compransion zone 115 in combination with at least one of the interfaces 130 and the fasteners 140 can maintain a force on the metal arm members 111, 112 to force the metal compransion zone 115 to contract or expand in proportion to, respectively, the contraction or expansion of the glass mounting portion 35, and, thereby, restrict the overall width of the clamp 110 to the limited width D1 (ΔT), in which the width D₁₁₅ of the compransion zone 115 is kept equal to the width D1B of the glass mounting portion 35 at all times.

In at least embodiment, the mounting portion 35 is made of glass and the arm members 111, 112, 113 are each made of the same metal, in which case the glass mounting portion 35 will contract at a different rate than that of the arm members 111, 112, 113; and the arm members 111 and 112 will contract at substantially the same rate as the non-compransion portions of the arm member 113. The compransion zone 115, however, will contract at the same rate as the glass mounting portion 35. The contraction of the compransion zone 115 is limited by the contraction of the mounting portion 35, wherein the channels 1151, 152 facilitate this limiting of contraction. In this regard, the combination of the interfaces 130 and/or the fasteners 140 can maintain a force on the metal arm members 111, 112 to force the metal compransion zone 115 to contract in proportion to the contraction of the glass mounting portion 35 and, thereby, restrict the width of the clamp 110 to the limited width D1 (ΔT), where the limited width D1 (ΔT) is less than the baseline width D2 (ΔT), but greater than the unrestricted width D3.

On the other hand, as temperature increases above the baseline temperature, the arm members 111 (width D1A), 112 (width D1C), 113 (width D1B), and mounting portion 35 (width D₁₁₅) can expand at different rates due to their respective CTE values, such that the limited width D1 will become larger than the baseline width D2 (D2<D1), but smaller than the unrestricted width D3. Since the mounting portion 35 is made of glass and the clamp 110 is made of metal, the glass will expand at a different rate than that of the metal arm members 111, 112, 113; and the metal arm members 111 and 112 will expand at substantially the same rate as the non-compransion portions of the arm member 113. The compransion zone 115, however, will expand, or be limited to expand, at the same rate as the glass mounting portion 35.

In various embodiments, the values D1, D1 (ΔT), D1A, D₁₁₅, D1B, D1C, and D2, which can be referred to in terms of either width or length, can be determined according to the following equation Eq. 1:

$$D 1 ( Δ T ) = ( D 1 A \cdot {α}_{m} \cdot Δ T ) + ( D 1 B \cdot {α}_{g} \cdot Δ T ) + ( D 1 c \cdot {α}_{m} \cdot Δ T ) \qquad [ Eq . 1 ]$$

$${D}_{115} ( Δ T ) = ( D 1 B \cdot {α}_{g} \cdot Δ T ) \qquad [ Eq . 2 ]$$

$$D 3 ( Δ T ) = D 2 \cdot {α}_{m} \cdot Δ T \qquad [ Eq . 3 ]$$

$$Δ T = Tc - {T}_{0} \qquad [ Eq . 4 ]$$

where:
ΔT is the temperature differential from an initial temperature value T₀ (for example, the baseline temperature) to the current temperature value T_{C};
D1 (ΔT) is the limited width of the clamp 110 (including mounting portion 35) after contraction or expansion of the clamp 110 and mounting portion 35 for the temperature differential ΔT;
D115 (ΔT) is the limited width of the compransion zone 115 after contraction or expansion for the temperature differential ΔT;
D3 (ΔT) is the unrestricted width a clamp 110 without the compransion zone 115, after contraction or expansion for the temperature differential ΔT;
α is a coefficient of thermal expansion (CTE) for a material;
αₘ is the CTE coefficient of the metal used to make the clamp 110 (including the arm members 111, 112, 113);
α_{g} is the CTE coefficient of the glass used to make the mounting portion 35; and
αₘ≠α_{g}.

As seen from the preceding paragraph, initially the limited width D1 is equal to the baseline width D2 and the unrestricted width D3 (D1=D2=D3) at the baseline temperature. However, as temperature increases above the baseline temperature T_{BaseLine}, the limited width D1 becomes bigger than the baseline width D2, but smaller than the unrestricted width D3 (D3>D1>D2) for the embodiment comprising a metal clamp 110 and glass mounting portion 35. And, as temperature decreases below the baseline temperature T_{BaseLine}, the limited width DI becomes smaller than the baseline width D2, but larger than the unrestricted width D3 (D2>D1>D3). The compransion zone 115 (either alone or in combination with the interfaces 130 and/or fastener(s) 140) accommodates the mismatch in CTE values between the metal clamp 110 and glass mounting portion 35, thereby mitigating or eliminating the risks the clamp 110 would otherwise present to the mounting portion 35 due to changes in temperature, such as, for example, the metal clamp becoming loose with respect to the glass mounting portion at higher temperatures, or fracturing the glass mounting portion at lower temperatures.

The terms “a,” “an,” and “the,” as used in this disclosure, means “one or more,” unless expressly specified otherwise.

The terms “including,” “comprising” and their variations, as used in this disclosure, mean “including, but not limited to,” unless expressly specified otherwise.

References in the disclosure to “one embodiment,” “an embodiment,” “an example embodiment,” or “example,” indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format can be interpreted in a flexible manner to include not only the numerical values explicitly recited as the limits of the range, but also to include all the individual numerical values or sub-ranges encompassed within that range as if each numerical value and sub-range is explicitly recited.

The term “or” is used to refer to a nonexclusive “or” unless otherwise indicated. Unless indicated otherwise, the statement “at least one of”' when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1”” is equivalent to “0.0001.”

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. An apparatus for connecting one or more parts having different coefficients of thermal expansion, the apparatus comprising:
a clamp configured to attach to a support, the clamp comprising
a first arm member having a first contact surface,
a second arm member having a second contact surface,
a recess formed by the first arm member and the second arm member, and
a third arm member positioned perpendicular to at least one of the first arm member and the second arm member, the third arm member having a compransion zone;
a base configured to hold a component, the base comprising a body that holds the component in a fixed position; and
an interface configured to engage or attach to at least one of the first contact surface and the second contact surface,
wherein a width of the compransion zone is kept substantially equal to a width of the recess under varying temperature conditions to minimize or eliminate any stress to the support caused by thermal expansion or contraction of the clamp.

2. The apparatus of claim 1, wherein the component comprises a beam steering assembly.

3. The apparatus of claim 1, wherein the compransion zone comprises at least one of one or more channels and one or more counter-channels.

4. The apparatus of claim 1, wherein the interface comprises an elastomer.

5. The apparatus of claim 4, wherein the elastomer comprises a thin polymer.

6. The apparatus of claim 1, wherein the at least one of the one or more channels and the one or more counter-channels have a length equal to a height of the third arm member.

7. The apparatus of claim 1, wherein the at least one of the one or more channels and the one or more counter-channels comprise a plurality of longitudinal cuts along a length of the third arm member.

8. The apparatus of claim 7, wherein the plurality of longitudinal cuts are parallel to each other.

9. The apparatus of claim 7, wherein the one or more channels each comprise a longitudinal cut along a first side of the third arm member, and wherein the one or more counter-channels each comprise a longitudinal cut along a second side of the third arm member, the second side being opposite the first side.

10. The apparatus of claim 9, wherein the second side comprises a contact surface.

11. The apparatus of claim 10, wherein the interface comprises three interface sections, each interface section being configured to be positioned between a surface of the support and one of said contact surface, the first contact surface, and the second contact surface.

12. The apparatus of claim 1, wherein the clamp, including the compransion zone, is made of metal having a coefficient of thermal expansion αₘ and the support is made of glass having a coefficient of thermal expansion α_{g}.

13. The apparatus of claim 12, wherein the compransion zone is configured to mimic the coefficient of thermal expansion α_{g} under varying temperatures.

14. The apparatus of claim 13, wherein the compransion zone is further configured to cooperate with one or more fasteners to mimic the coefficient of thermal expansion α_{g}.

15. The apparatus of claim 1, wherein the body comprises a receiver configured to seat and secure the component to the base.

16. The apparatus of claim 15, wherein the body comprises a pair of legs, either or both legs being configured to adjust a diameter of the receiver.

17. The apparatus of claim 15, wherein the body comprises a longitudinal aperture configured to adjust a diameter of the receiver.

18. The apparatus of claim 16, wherein the body comprises a pair of normal apertures, each normal aperture being configured to facilitate movement of one of the pair of legs.

19. The apparatus of claim 1, wherein the clamp and the base are formed as a single monolithic structure.

20. The apparatus of claim 16, further comprising one or more fasteners configured to affix either the first arm member to the second arm member or the pair of legs to each other.
